(19) United States
(12) Patent Application Publication
(10) Pub. No.: US 2014/0227977 A1
(43) Pub. Date: Aug. 14, 2014

(54) METHOD, NODE, DEVICE, AND COMPUTER PROGRAM FOR INTERACTION

(71) Applicant: Zary Segall, Stockholm (SE)

(72) Inventors: Zary Segall, Stockholm (SE); Pietro Lungaro, Stockholm (SE); Chad Eby, Bandhagen (SE)

(21) Appl. No.: 14/178,803

(22) Filed: Feb. 12, 2014

Related U.S. Application Data
(63) Continuation-in-part of application No. 14/080,837, filed on Nov. 15, 2013.
(60) Provisional application No. 61/763,730, filed on Feb. 12, 2013.
(60) Provisional application No. 61/904,480, filed on Nov. 15, 2013.
(60) Provisional application No. 61/909,404, filed on Nov. 27, 2013.
(60) Provisional application No. 61/763,730, filed on Feb. 12, 2013.

(51) Int. Cl. H04W 76/02

(52) U.S. Cl. CPC H04W 76/023
USPC 455/41.2

(57) ABSTRACT

A method, interaction node (100) and computer program in a communication network for enabling interactivity between single or multiple handheld devices (110) and an object (120), comprising receiving at least one orientation message from the handheld devices (110), further comprising determining the handheld devices (110) position and direction in a predetermined vicinity space (130), further comprising determining an object (120) in the vicinity space (130) to which the handheld device (110) is oriented, further comprising transmitting an indicator to a feedback unit (140), which indicates that the handheld device (110) is oriented toward the object (120), the indicator confirming a desired orientation of the handheld device (110) such that the handheld device (110) is pointing at the desired object (120), further comprising receiving an interaction message from the handheld device (110) including a selection of the object (120), thereby enabling interaction between the handheld devices (110) and the object (120).

### TECHNICAL FIELD

The present disclosure relates generally to methods, a node, a device and computer program in a communication network for enabling interactivity between a device and an object.

### BACKGROUND

Recently, devices such as smart phones, mobile phones and similar mobile devices have become more than just devices for voice communication and messaging. The devices are now used for running various applications, both as local standalone applications, and as applications in communication with remote applications outside the device. Applications outside the device may be installed on a computer in a vicinity of the device, or the application may be installed at a central site such as with a service provider, network operator or within a cloud-based service.

The devices are moving towards general availability for every person, and have become capable of much more than just voice telephony and simple text messaging.

There are various areas where it may be desired that an application within a device may communicate with applications outside the device. Further it is a long-held desire to be able to interact with and gain information about general everyday objects. Examples of such areas include user-initiated information acquisition, task guidance, way-finding, education, and commerce.

It is a problem for users to intuitively start an interaction within a device in order to interact with a general object or application. Another problem is where a plurality of users wishes to interact through their personal devices with the same object or group of co-located objects.

### SUMMARY

It is an object of the invention to address at least some of the problems and issues outlined above. It is possible to achieve these objects and others by using a method, node, device and computer program.

According to one aspect, a method is provided in an interaction node in a communication network for enabling interactivity between single or multiple devices and an object. The method comprises receiving at least one orientation message from the devices. The method further comprises determining the devices position and direction in a predetermined vicinity space. The method further comprises determining an object in the vicinity space to which the device is oriented. The method further comprises transmitting an indicator to a feedback unit, which indicates that the device is oriented toward the object, the indicator confirming a desired orientation of the device such that the device is pointing at the desired object. The method further comprises receiving an interaction message from the device including a selection of the object. Thereby enabling interaction between the devices and the object.

According to another aspect, an interaction node is provided in an in a communication network for enabling interactivity between a device and an object. The node is configured to receive at least one orientation message from the devices. The node is configured to determine the device position and direction in a predetermined vicinity space. The node is configured to determine an object in the vicinity space to which the device is oriented. The node is configured to transmit an indicator to a feedback unit, which indicates that the device is oriented toward the object, the indicator confirming a desired orientation of the device such that the device is pointing at the desired object. The node is configured to receive an interaction message from the device including a selection of the object. Thereby enabling interaction between the device and the object.

According to another aspect, a computer program and a computer program product is provided to operate in an interaction node and perform the method steps provided in a method for an interaction node.

The above method, node and computer program may be configured and implemented according to different optional embodiments. In one possible embodiment, the object has at least one of: a pre-determined position in the vicinity space determined by use of information from a spatial database, and a dynamically determined position in the vicinity space, determined by use of vicinity sensors. In one possible embodiment, the feedback unit is a light emitting unit, wherein the transmitted indicator includes an instruction to emit a pointer at the object, coincident with the object in the orientation of the device. In one possible embodiment, an accuracy of the orientation is indicated by visual characteristics of the pointer. In one possible embodiment, the device and the feedback unit are associated, wherein the transmitted indicator includes an instruction to generate at least one of: haptic signal, audio signal, and visual signal that confirms that the device is oriented toward the object. Visual signal could be manifested both by display of information on the device screen or, if the device supports light emitting units (e.g. a mobile device with integrated projector) by actual light emission of a pointer. In one possible embodiment, the node transmits the received interaction message to the object, wherein network address information to the device is added to the transmitted interaction message, enabling direct communication between the object and the device. In one possible embodiment, the node transmits an image of the vicinity space to the device, the image describing an area and at least one object 120 within the area, wherein the area is determined by the device position and orientation, corresponding to a virtual projection based on the device position and orientation. In one possible embodiment, the node receives a first image of the projection from the device or a camera 145, the image including at least one captured object, mapping the at least one object captured in the image with the corresponding object in the spatial database, and transmitting a second image to the device, wherein the second image includes information and/or instructions for creations of at least one interaction message related to the at least one object.

According to another aspect, a method in a device in a communication network is provided for enabling interactivity between the device and an object. The method comprises transmitting at least one orientation message to an interaction node. The method comprises transmitting an interaction message from the device including a selection of the object, thereby enabling interaction between the device and the object.

According to another aspect, a device in a communication network is provided for enabling interactivity between the device and an object. The device is configured to transmit at least one orientation message to an interaction node. The device is configured to transmit an interaction message from the device including a selection of the object, thereby enabling interaction between the device and the object.

According to another aspect, a computer program and a computer program product is provided to operate in a device and perform the method steps provided in a method for a device.

The above method, device and computer program may be configured and implemented according to different optional embodiments. In one possible embodiment, the node transmits an indicator to a feedback unit, which indicates that the device is oriented toward the object, the indicator confirming a desired orientation of the device such that the device is pointing at the desired object. In one possible embodiment, the device and the feedback unit are associated, wherein the received indicator includes an instruction to generate at least one of: haptic signal, audio signal, and visual signal that confirms that the device is oriented toward the object. In one possible embodiment, the node transmits a vicinity image of the vicinity space, the image describing an area and at least one object within the area, wherein the area is determined by the device position and orientation, corresponding to a virtual projection based on the device position and orientation. In one possible embodiment, the device transmits a first captured image of the projection to the interaction node, the first captured image including at least one captured object, and receiving a second captured image to the device, wherein the second captured image includes information and/or instructions for creation of at least one interaction message related to the at least one object.

An advantage with the solution is that users with an ordinary device, such as a smart phone, may start an interaction with an object enabled by the described solution, without need of any further equipment.

An advantage with the described solution is that the solution may replace touch screens adopted for multiple concurrent users. Such multiple user screens are expensive compared to the described solution based on standard computers, optionally light emitting units and the devices provided by users.

According to one aspect, a method is provided in an interaction node in a communication network for enabling interactivity between single or multiple devices and an object. The method comprises receiving at least one orientation message from the devices. The method further comprises determining the devices' positions and directions in a predetermined vicinity space. The method further comprises, for each device, determining an object in the vicinity space to which the device is oriented. The method further comprises, for each device, transmitting an indicator to a feedback unit, which indicates that the device is oriented toward the object, the indicator confirming a desired orientation of the device such that the device is pointing at the desired object. The method further comprises, for each device, receiving an interaction message from the device including a selection of the object. The method further comprises, for each device, the selection of a set of possible manifestations at the device resulting from the interaction with that specific object. The method further comprises, for each device, means for the user to activate a wanted interaction manifestation.

According to another aspect, an interaction node is provided in a communication network for enabling interactivity between single or multiple devices and an object. The node is configured to receive at least one orientation message from the devices. The node is configured to determine, for each device, the device position and direction in a predetermined vicinity space. The node is configured to determine, for each device, an object in the vicinity space to which the device is oriented. The node is configured to transmit, for each device, an indicator to a feedback unit, which indicates that the device is oriented toward the object, the indicator confirming a desired orientation of the device such that the device is pointing at the desired object. The node is configured, for each device, to receive an interaction message from the device including a selection of the object. The node is configured, for each device, to perform the selection of a set of possible manifestations at the device resulting from the interaction with that specific object. The node is configured, for each device, to further support the activation of a wanted interaction manifestation at the terminal side. According to one embodiment, a terminal is a handheld device 110.

According to another aspect, a computer program and a computer program product is provided to operate in an interaction node and perform the method steps provided in a method for an interaction node.

The above method, node and computer program may be configured and implemented according to different optional embodiments. In particular, all previously described embodiments are supported and further enhanced by a mechanism for performing the selection of the manifestation in the device of an interaction with a specific object. The embodiments of this aforementioned selection mechanism can be performed within an information node 300 and based on different types of context information, including but not limited to time, location, user, and device and network information. This information can be stored in dedicated databases within the information node 300, as shown in FIG. 12 and the decision performed according to specific semantic rules 400. In one such embodiment, the type of manifestation in the device can vary in time according to a pre-defined schedule stored in 420. In another embodiment instead the mechanism adopted in the system can decide the interaction manifestation at the terminal considering specific characteristics of the terminal 440, including but not limited to energy levels, screen resolution, if it is a wearable (e.g. smart glasses or smart watch) or a handheld device (e.g. a smartphone). In another embodiment the decision mechanisms could instead select the specific device manifestation considering the performances of the network to which the mobile device is connected 450. In another embodiment the decision on the type of manifestation can depend on characteristics of the user of the device. Such characteristics could include, but are not limited to, age, gender, previous interactions with other objects, metadata associated with previous objects etc. These characteristics can be learned by the system in time and/or provided by other means and stored in 410. In another embodiment the decision of the interaction manifestation at the device can consider the aggregated information of all users whose terminals are currently connected with a given object. Finally various embodiments of the aforementioned selection mechanism can include and process information concerning multiple types of context information.

According to one aspect, a method is provided in an interaction node in a communication network for enabling interactivity between single or multiple devices and an object. The method comprises, for each device, receiving at least one orientation message from the devices. The method further comprises determining the devices' positions and directions in a predetermined vicinity space. The method further comprises, for each device, determining an object in the vicinity space to which the device is oriented. The method further comprises, for each device, transmitting an indicator to a feedback unit, which indicates that the device is oriented toward the object, the indicator confirming a desired orientation of the device such that the device is pointing at the desired object. The method further comprises, for each device, receiving an interaction message from the device including a selection of the object. The method further comprises means to alter the state of the object, for example but not limited to object illumination characteristics. The method further comprises, for each device, the selection of a manifestation in the object corresponding to the interaction with that specific terminal.

According to another aspect, an interaction node is provided in a communication network for enabling interactivity between single or multiple devices and an object. The node is configured to receive at least one orientation message from the devices. The node is configured to determine, for each device, the device position and direction in a predetermined vicinity space. The node is configured to determine, for each device, an object in the vicinity space to which the device is oriented. The node is configured to transmit, for each device, an indicator to a feedback unit, which indicates that the device is oriented toward the object, the indicator confirming a desired orientation of the device such that the device is pointing at the desired object. The node is configured to receive, for each device, an interaction message from the device including a selection of the object. The node is configured to directly or indirectly (e.g. though another node) alter the state of the object, for example but not limited to the object illumination characteristics. The node further performs the selection of a manifestation at the object of such interaction with those specific terminals.

According to another aspect, a computer program and a computer program product is provided to operate in an interaction node and perform the method steps provided in a method for an interaction node.

The above method, node and computer program may be configured and implemented according to different optional embodiments. In particular, all previously described embodiments are supported and further enhanced by a mechanism for performing the selection of the manifestation in the device of an interaction with a specific object. The type of manifestation at the object could be represented by audio, haptic, specific lighting properties, not limited to color, saturation and image overlay, localized sound and vibration patterns etc. Instead, for objects like connected screens, e.g. digital signage screens or posters illuminated by projectors connected to a server, the manifestation can be represented by displaying a specific image or video effect in the screen or overlay over the object. The manifestation at the object could be changed instantaneously or at pre-defined discrete time instants. Information concerning the object manifestation is stored in the portion of the content database 310 that is specifically dedicated to object content 520. The decision process is performed in a semantic module 400 that has also access to databases containing context information 320. In one embodiment the mechanism adopted in the system can select manifestation at the objects based on specific characteristics of the connected terminal 440, including but not limited to if it is a wearable (e.g. smart glasses or smart watch) or an handheld device (e.g. a smartphone). In another embodiment the selection mechanisms could instead decide on the specific object manifestation considering the performances of the network to which the screen or projector controlling unit is connected. In another embodiment the decision on the type of manifestation can depend on characteristics of the user of the connected device 410. Such characteristics could include, but not limited to, age, gender, previous interactions with other objects, metadata associated with previous objects etc. These characteristics can be learned by the system in time and/or provided by other means. In another embodiment the decision of the manifestation of the interaction at the object could be based on the aggregated information of all users whose terminals are currently connected with it.

According to one aspect, a method is provided in an interaction node in a communication network for enabling interactivity between single or multiple devices and an object. The method comprises receiving at least one orientation message from the devices. The method further comprises, for each device, determining the devices position and direction in a predetermined vicinity space. The method further comprises determining, for each device, an object in the vicinity space to which the device is oriented. The method further comprises, for each device, transmitting an indicator to a feedback unit, which indicates that the device is oriented toward the object, the indicator confirming a desired orientation of the device such that the device is pointing at the desired object. The method further comprises, for each device, receiving an interaction message from the device including a selection of the object. The method further comprises means to alter the state of the object, for example but not limited to object illumination characteristics. The method further comprises the selection of manifestations in multiple objects, one of which might include the selected object, resulting from the interaction with those specific terminals.

According to another aspect, an interaction node is provided in an in a communication network for enabling interactivity between single or multiple devices and an object. The node is configured to receive at least one orientation message from the devices. The node is configured, for each device, to determine the device position and direction in a predetermined vicinity space. The node is configured, for each device, to determine an object in the vicinity space to which the device is oriented. The node is configured, for each device, to transmit an indicator to a feedback unit, which indicates that the device is oriented toward the object, the indicator confirming a desired orientation of the device such that the device is pointing at the desired object. The node is configured, for each device, to receive an interaction message from the device including a selection of the object. The node is configured to directly or indirectly (e.g. though another node) alter the state of the object, for example but not limited to the object illumination characteristics. The node further performs the selection of manifestations in multiple objects, one of which might be the selected object, resulting from the interaction with those specific terminals.

According to another aspect, a computer program and a computer program product is provided to operate in an interaction node and perform the method steps provided in a method for an interaction node.

The above method, node and computer program may be configured and implemented according to different optional embodiments. In particular, these can expand the previously described embodiments by supporting the activation of manifestations on multiple objects, one of which could be the object selected by the terminal. In particular the case in which the manifestations involves multiple objects which are logically associated with the selected object.

A specific preferred embodiment is the case in which manifestations are activated in both the selected object and on another object which is a connected screen, e.g. projector or digital signage screen, in which content related to the selected object is displayed.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is a block diagram illustrating the solution, according to some possible embodiments.

FIG. 2 is a flow chart illustrating a procedure in an interaction node, according to further possible embodiments.

FIG. 3 is a block diagram, according to some possible embodiments with separated feedback unit.

FIG. 4 is a block diagram, according to further possible embodiments with integrated feedback unit.

FIG. 5 is a block diagram illustrating the solution in more detail, according to further possible embodiments.

FIG. 6 is a block diagram illustrating an interaction node and device, according to further possible embodiments.

FIG. 7 is a block diagram illustrating the solution according to further possible embodiments.

FIG. 8 is a block diagram illustrating an interaction node and device, according to further possible embodiments.

FIGS. 9-13 disclose block diagrams illustrating the solution according to further possible embodiments of implementation.

### DETAILED DESCRIPTION

Briefly described, a solution is provided to enable single users or multiple simultaneous users to use a device to point at and start an interaction with objects. The objects may be two dimensional objects, three dimensional objects, physical objects, graphical representation of objects, objects that are displayed by a light emitting device including but not limited to a video/data projector, digital displays, etc., or objects which comprises computers themselves.

The solution for selecting by one or multiple users, with visual and/or haptic and/or audio effects—objects in a user's proximal physical space, and connect such selection with actions and information in the mobile or wired Internet information space. 2D/3D objects may include but are not limited to physical objects, graphical representation of objects, objects that are displayed by a light emitting device may also be denoted “object 120”. Proximal physical space may also be denoted “user's field of vision” or “vicinity space 130”.

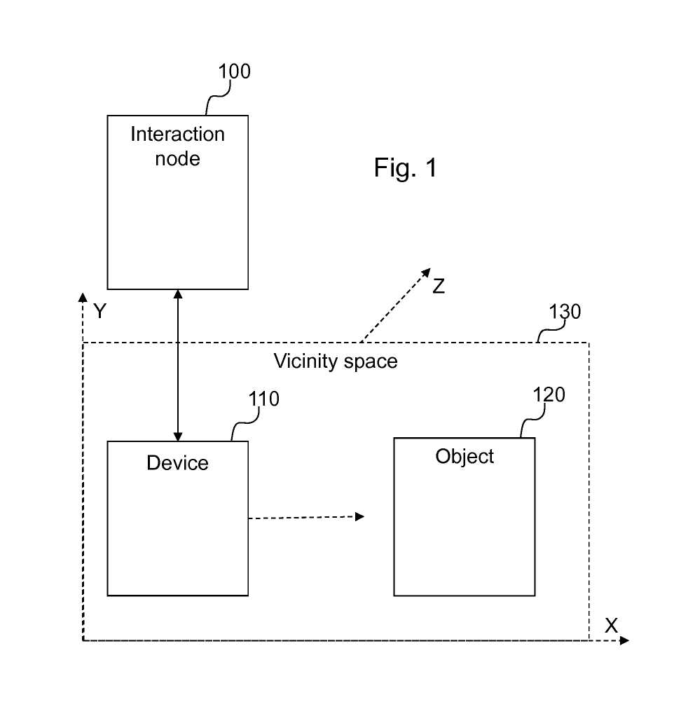

FIG. 1 shows an illustrative embodiment, of a device such as the handheld device 110. Example of a device 110 is: a networked handheld and/or wearable device, for example comprising, but not limited to, a “smart phone” or tablet computer, smart watch, head mounted device. The device 110 may comprise various types of user interfaces, such as visual display, means for haptic feedback such as vibratory motors, etc., audio generation, for example through speakers or headphones. The device may further comprise one or more sensors for determining device orientation/position for example such as accelerometers, magnetometers, gyros, tilt sensors, compass, etc. An interaction node, such as the interaction node 100 may also be denoted “second networked device”.

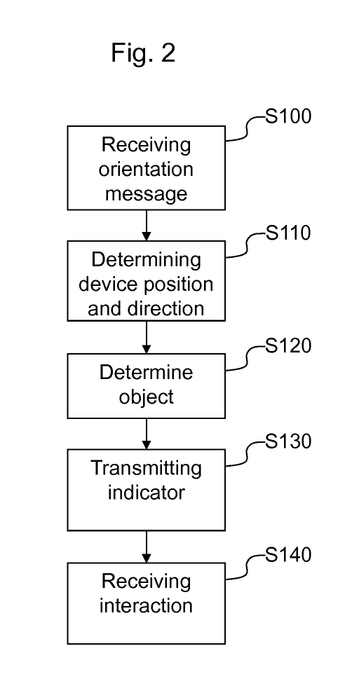

FIG. 2 illustrates a procedure in an interaction node 100 in a communication network for enabling interactivity between a handheld device 110 and an object 120. The interaction node 100 may receive S100 at least one orientation message from the handheld device 110. The interaction node 100 may determine S110 the handheld device 110 position and orientation in a predetermined vicinity space 130. The interaction node 100 may determine S120 an object 120 in the vicinity space 130 to which the handheld device 110 is oriented. The interaction node 100 may transmit S130 an indicator to a feedback unit, which indicates that the handheld device 110 is oriented toward the object 120, the indicator confirming a desired orientation of the handheld device 110, such that the handheld device 110 is pointing at the desired object 120. The interaction node 100 may receive S140 an interaction message from the handheld device 110 including a selection of the object 120. Thereby is interaction between the handheld device 110 and the object 120 enabled.

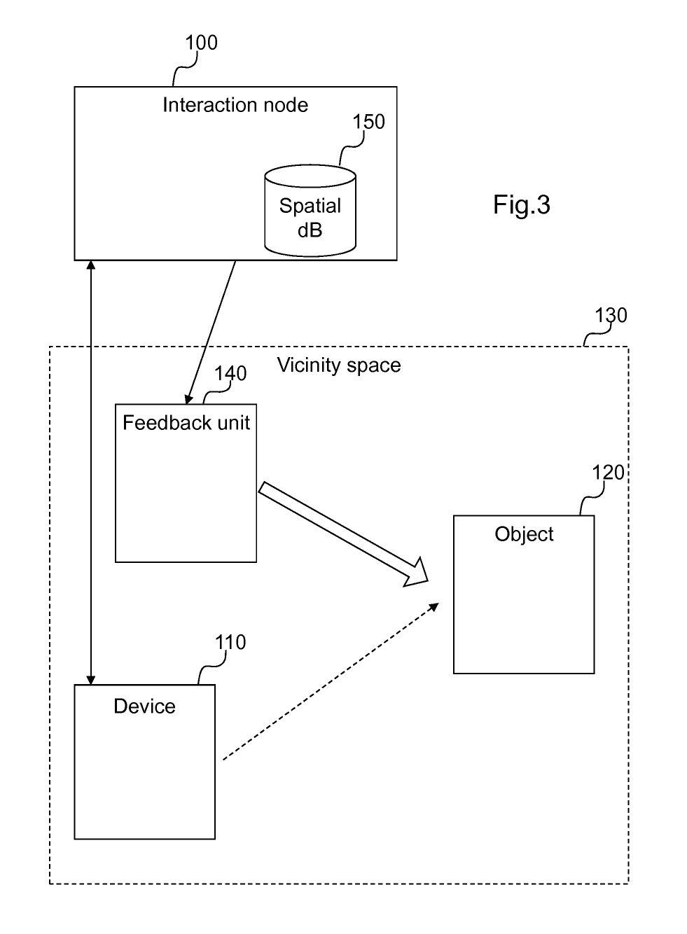

FIG. 3 illustrates an embodiment of the solution with the interaction node 100, the handheld device 110 and an object 120. The interaction node 100 may be connected to a feedback unit 140. The handheld device 110 may determine proximity, orientation and may receive user requests and/or actions and by wire or wirelessly transmit the handheld device 110 proximity, orientation and user requests and/or actions to the interaction node 100. The interaction node 100 may have access to a spatial representation that may map the handheld device 110 proximal physical space into an information space that contains specific data and allowed actions about a single object 120, all objects 120 in a group of objects 120, or a subset of objects 120 in group of objects 120. The spatial representation may be static or dynamically generated. Examples of objects 120 are: physical objects, virtual objects, printed images, digitally displayed or projected images, not limiting to other examples of an object 120 or a 2D/3D object, including also connected objects such as digital displays, computer screens, TV screens, touch screens, single user touch screens, multiple user touch screens and other possible connected appliances and devices. Examples of a feedback unit 140 is: digital display, computer screen, TV screen, touch screen, single user touch screen, multiple user touch screen, head mounted display, digital projector, device incorporating digital projectors and/or digital screen, not limiting to other units. The spatial representation may be stored in a database, such as the spatial database 150.

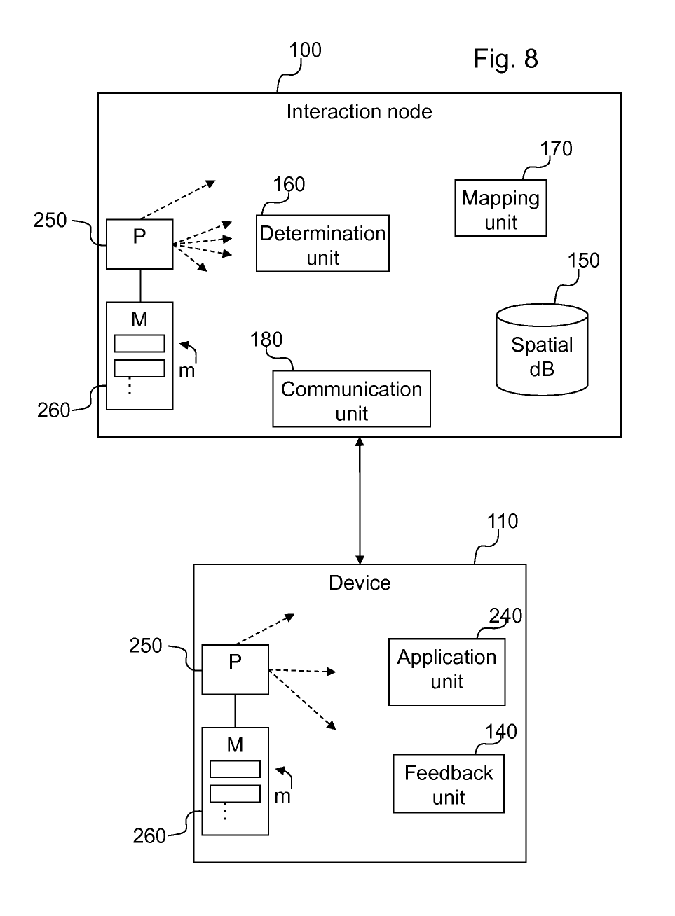

A determination unit 160 may generate the position of a visual indicator. The visual indicator may be further referred to as a pointer, the position of which might be computed using information which may comprise, but is not limited to: 1. A user-selected 2D/3D visible position for the pointer. 2. the networked wireless handheld and/or wearable handheld device 110 orientation corresponding to 1., 3. All other pointer positions may be calculated relative to 1. and 2. The spatial database 150 and determination unit 160 is further described in relation to FIG. 8.

The determination unit 160 may generate the trigger for an audio and/haptic indicator, using a method which may comprise, but is not limited to: 1. A user-selected 2D/3D position for audio and/or haptic manifestation of the trigger. 2. The networked wireless handheld and/or wearable device orientation corresponding to 1., 3. All other trigger positions may be calculated relative to 1. and 2.

The second networked device 100 and the light emitting device 140: 1) may create a visible pointer on the surface of physical 2D and 3D objects, 2) may facilitate user interaction through the networked wireless handheld and/or wearable device with those objects through pointing, highlighting, and allowing the user operations including but not limited to “click”, search, identify, etc., on those selected objects, and 3) may transmit information back to the handheld and/or wearable device, about the 2D and 3D objects selected by said pointer.

The second networked device 100 and the handheld device 110: 1) may create a visual and/or audio and/or haptic manifestation on the handheld device 110, 2) may facilitate user interaction through the handheld device 110 with objects 120 through pointing, highlighting, and allowing the user operations including but not limited to “click”, search, identify, etc., on those selected objects, and 3) may transmit information back to the handheld and/or wearable device, about the 2D and 3D objects selected by said pointer and or audio and/or haptic manifestations. Communication may be performed over wired or wireless communication.

The mapping calculation performed by the second networked device 100 may use the absolute positioning information provided by handheld device 110 or only variations relative to the position and orientation recorded at the moment of initial communication represented by the pointer and/or audio and/or haptic manifestations at the user-selected visible position. The mapping calculation may be performed by mapping unit 170. The mapping unit 170 is further described in relation to FIG. 8.

In determining the position of a terminal the second networked device 100 may also access positioning information that can be provided by a network infrastructure available in the vicinity space, including but not limited to cellular positioning, wifi or even low power Bluetooth sensors.

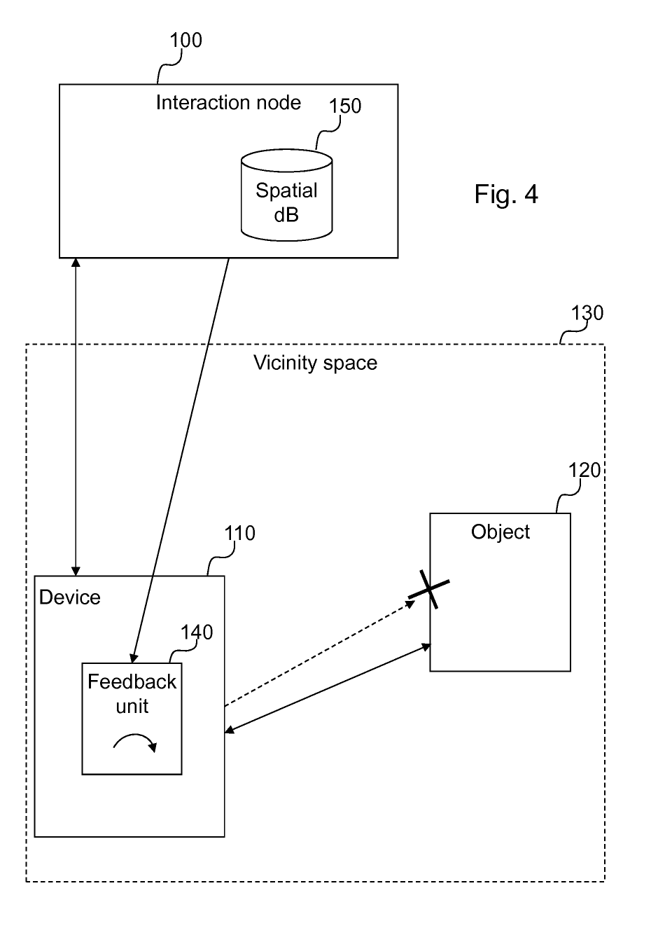

FIG. 4 illustrates exemplifying embodiments of the solution where the second networked device 100 may further be used to transmit commands to the handheld device 110 that may be activating the device's 110 haptic, visual or audio interface to indicate the presence of specific 2D/3D object and/or graphic displays of the object in the user's proximal physical space. In this embodiment the handheld device 110's internal haptic, visual or audio interface may be controlled by the feedback unit 140. The feedback unit 140, in this case may be a functional unit of the handheld device 110. The feedback unit 140 may as well be external to the handheld device 110, but communicating with the handheld device 110 internal haptic, visual or audio interface. The second networked device 100 may perform a match between the handheld device 110 location and orientation and the object spatial representation map. The second networked device 100 may facilitate user interaction with those objects through pointing, highlighting, and allowing user operations such as “click”, search, identify, etc., on those selected objects. The second networked device 100 may transmit information back to the handheld device about the 2D and 3D objects selected by the user interaction for display and processing.

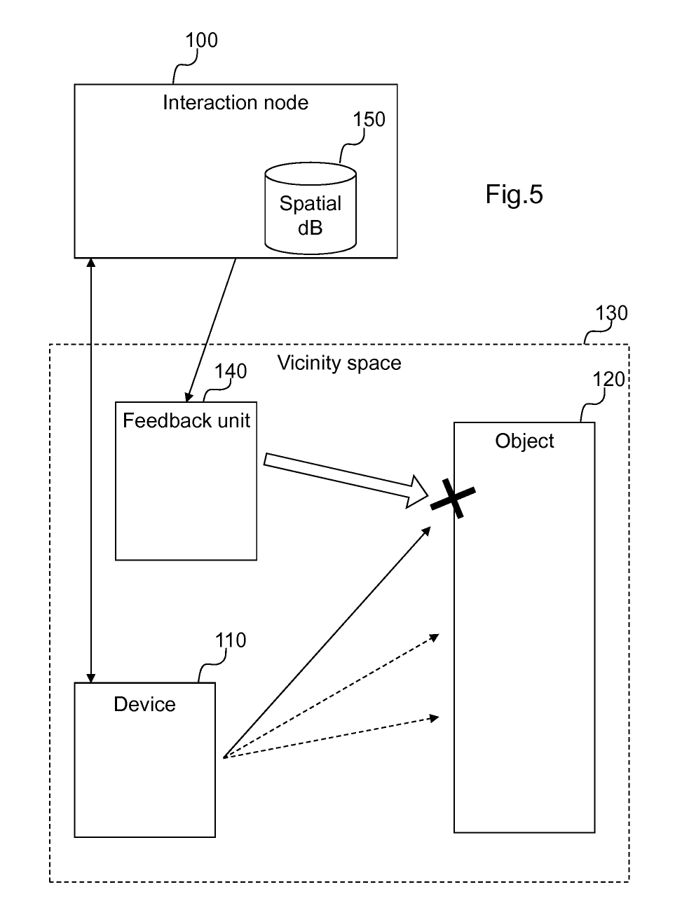

Another embodiment illustrated in FIG. 5, is comprised of 1. a networked wireless handheld and/or wearable handheld device 110, which may be conceived of, but is not limited to, a “smart phone” or tablet computer, smart watch, head mounted device, possessing a visual display, user interface, haptic feedback (vibratory motors, etc.), audio generation (through speakers or headphones) and one or more sensors for determining device orientation/position (such as accelerometers, magnetometers, gyros, tilt sensors, compass, etc.) and 2. a second networked device 100 which may be attached to 3. a light emitting device 140 including but not limited to a video/data projector and/or a digital panel display.

The networked wireless handheld and/or wearable handheld device 110 may determine proximity, orientation and receive user requests and/or actions and wirelessly transmit the device's proximity, orientation and user requests and/or actions to the second networked device 100 that has access to a spatial representation (static or dynamically generated) which may map the user's proximal physical space into an information space that contains specific data and allowed actions about all or a subset of objects displayed on or by the light emitting device 140.

The second networked device 100 and the light emitting device 140: 1) may create a visible pointer on the image displayed by the light emitting device 140, 2) may facilitate user interaction through the networked wireless handheld and/or wearable handheld device 110 with those displayed objects 120 through pointing, highlighting, and may allow user operations including but not limited to “click”, search, identify, etc., on those selected objects 120, and 3) may transmit information back to the handheld and/or wearable handheld device 110, about the displayed objects 120 selected by said pointer.

The mapping may determine the position of the pointer using a procedure which may include, but is not limited to: 1. A user-selected visible position for the pointer on the display generated by the said light emitting device 140. 2. The networked wireless handheld and/or wearable handheld device 110 orientation corresponding to 1., 3. All other said pointer positions may be calculated relative to 1. and 2. Thereby the orientation of the handheld device 110 may be calibrated, by the user pointing with the handheld device 110 in the direction of the visible pointer.

The mapping calculation performed by the second networked device 100 may use the absolute positioning information provided by said handheld device 100 or only variations relative to the position and orientation recorded at the moment of initial communication represented by said pointer at said user-selected visible position.

In another embodiment that is similar to the above described embodiments with the difference that the selected 2D/3D objects and/or graphic displays of the objects 120 in user's proximity, the objects 120 may be by themselves networked computers or contain networked computers and may respond to the selection by audio, visual, or haptic effects and/or by sending a message to the handheld device 110 and/or the second networked device 100.

In an embodiment, the handheld device 110 may present to the user a graphical representations of the objects 120 and the user may be enabled to navigate and select an object 120 by single or multiple finger screen touches or other gestures. Such a graphical representation may also be denoted scene.

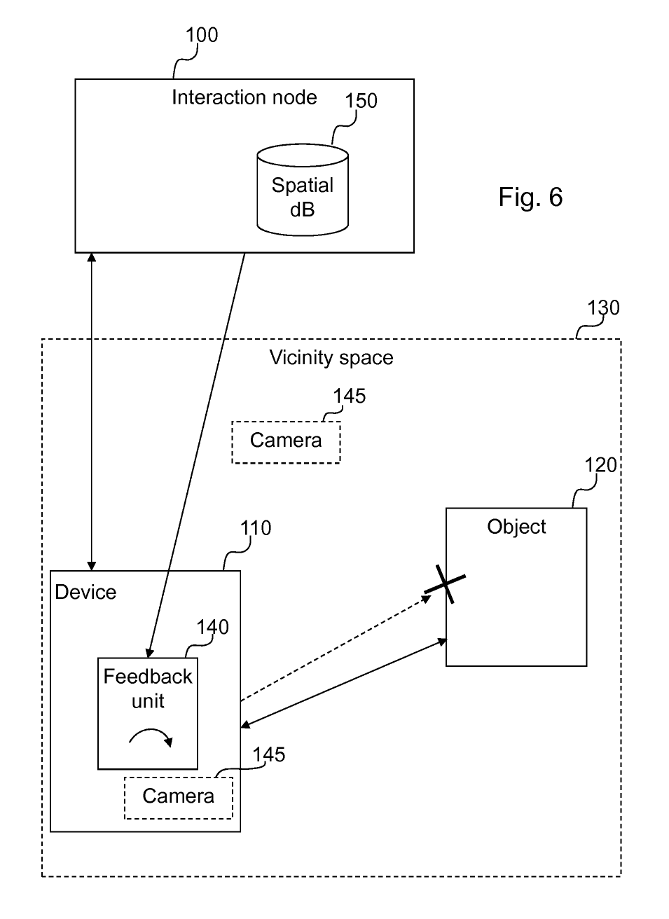

In an embodiment illustrated by FIG. 6 the handheld device 110 may be at least one of: associated with a camera 145, a camera 145 connected to the handheld device 110, and have a camera 145 integrated. Thereby may the handheld device 110 be enabled to acquire the scene in real time using the camera 145.

In an embodiment, the scene may be acquired by a remote camera 145. The camera may be remotely located with respect to handheld device 110's position but collocated with the objects 120 to be selected. The camera may be connected to the interaction node 110 via wire or wireless. In this embodiment also a feedback unit might be collocated with the objects 120 to be selected, allowing to remotely controlling the pointer from the device while providing visual feedback to the remote users via both images acquired from the camera and feedback on the device, e.g. haptic, screen information, sound etc.

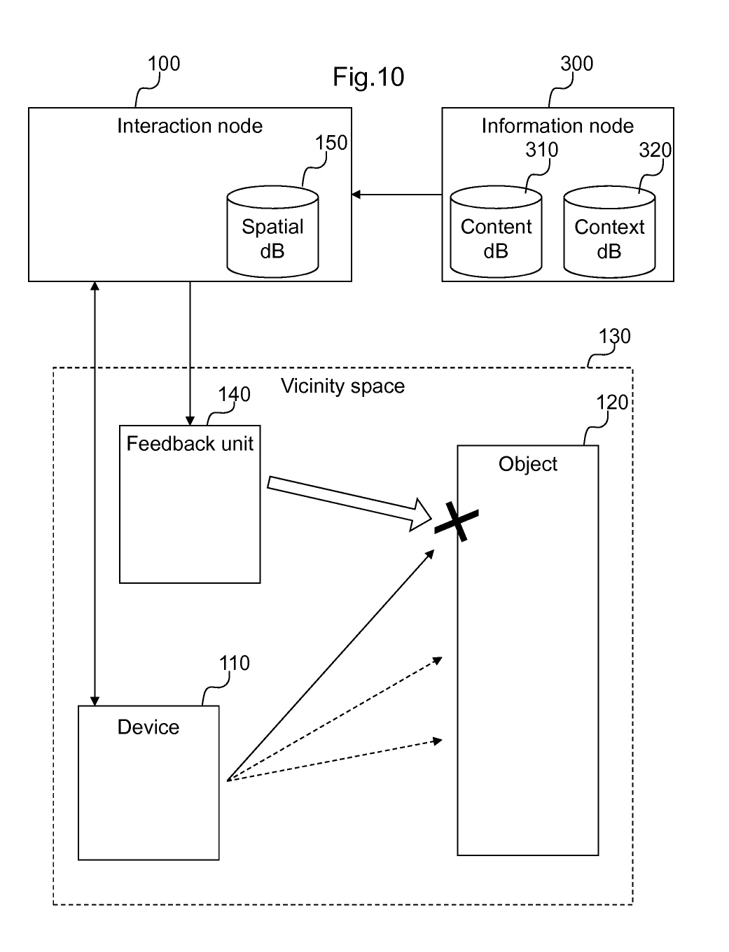

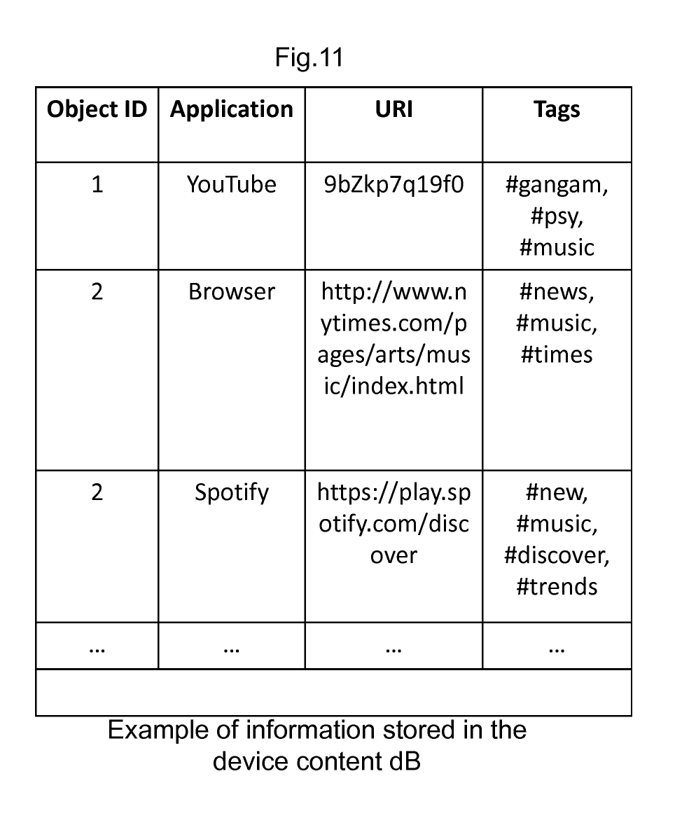

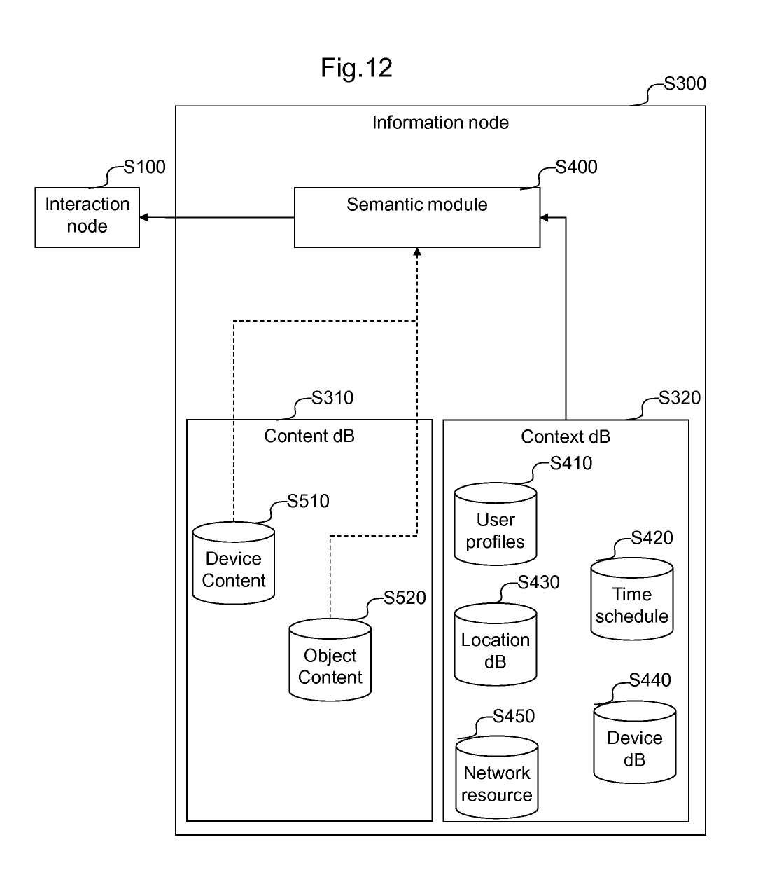

In another embodiment, a second networked device 100 may further be used to select specific manifestations resulting at the device side from the digital interaction with an object. A manifestation can be defined, but not limited to, as a tuple specifying a software application on the phone and an associated resource identifier, such as an Universal Resource Identifier. For example a manifestation could consist of a specific video on YouTube that provides additional information about the object to which the device is connected. Additional fields referring to a manifestation can also be provided, including also tags, i.e. metadata specifying the type of content (see FIG. 11). The various manifestations associated to an object can be stored in a content database 310 located within an information node 300 (see FIG. 10). Upon initiating the interaction with an object 120, a device 110 can receive one or more manifestations of the interaction from the interaction node 100. These manifestations have been selected by the interaction node 100, considering the information available in the context database 320, among all manifestations stored in the content database 310. In the preferred embodiment, when multiple manifestations are simultaneously available, these are presented through a specific interface to the user, while when a single manifestation is instead available this is typically initiated automatically.

In another embodiment that is similar with the above embodiment the information node 300 and the interaction node 100 can be coinciding. This essentially means that both content database 310 and context database 320 can be located within the interaction node 100.

In another embodiment, a second networked device 100 may further be used to select specific manifestations at the object side that are resulting from the digital interaction with a terminal. The set of possible manifestations for an object are included in a content database that is specific for the objects 520. Depending on the type of object different types of manifestations are possible. For objects that are not connected the preferred manifestations include lighting effects performed by the feedback unit 140 and triggered by the interaction node 100. Audio and/or haptic effects with sound devices associated to the object can also be used to deliver auditory feedback in the proximity of the object. In the case of the objects being connected screens, e.g. digital signage screens, the manifestations can be defined in a similar manner as for the user devices, e.g. as couples specifying a software application on the device (typically a video player) and an associated resource identifier, or URI. For example a manifestation could consist of launching on the screen a specific video from YouTube. Additional fields referring to a manifestation can also be provided, including also tags, i.e. metadata specifying the type of content (the structure is similar to the one in FIG. 11). The various manifestations associated to an object can be stored in a content database 310 located within an information node 300. Upon initiating the interaction with an object 120, a device 110 can trigger one or more manifestations of the interaction. These manifestations have been selected by the interaction node 100, considering the information available in the context database 320, among all manifestations stored in the content database 520.

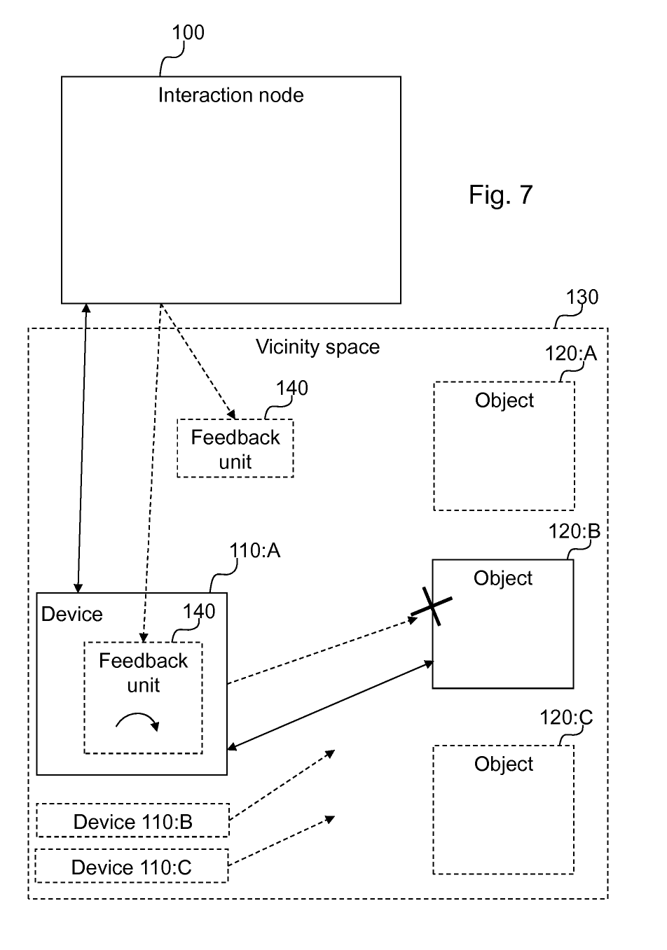

FIG. 7 illustrates an exemplifying embodiment of the solution comprising at least one and potentially a plurality of objects 120, such as object 120:A-C. Further, at least one handheld device 110 and potentially a plurality of devices 110, such as handheld device 110:A-C. The handheld device 110:A may be oriented to object 120:B, or a particular area of object 120:B, and further initiate an interaction associated with the object 120:B. The second handheld device 110:B may also be oriented at object 120:B, and may simultaneously initiate an interaction associated with the object 120:B, independently with the interaction carried out by the handheld device 110:A. Furthermore may the handheld device 110:C initiate an interaction with the object 120:C, independently of any other interactions, and potentially simultaneously with any other interactions. This is an example of where a number of devices 110 may be oriented at a number of objects 120. Further an example of that a number of devices 110 may carry out individual interactions with a single or a plurality of objects 120, simultaneously and independently of each other.

FIG. 8 illustrates the interaction node 100 and handheld device 110 in more detail. The interaction node 100 may comprise a spatial database 150. The spatial database 150 may contain information about the vicinity space 130. The information may be, for example, coordinates, areas or other means of describing a vicinity space 130. The vicinity space may be described as two dimensional, or three dimensional. The spatial database 150 may further contain information about objects 120. The information about objects 120 may for example comprise: relative or absolute position about the object 120, size and shape of a particular object 120, if it is a physical object 120 or a virtual object 120, if it is a virtual object 120 instructions of projection/display of the object 120, addressing and communication capabilities to the object 120 if the object 120 itself is a computer, not limiting other types of information stored in the spatial database 150. The determination unit 160 may be configured to determine the orientation of a handheld device 110. The determination unit 160 may further determine new orientations of the handheld device 110, based on a received orientation message from the handheld device 110. The determination unit 160 may also be configured to generate a pointer or projected pointer, for the purpose of calibrating a handheld device 110 orientation.

The mapping unit 170 may be configured to, based on a handheld device 110 determined orientations, map at which object 120 in a group of objects 120, the handheld device 110 is pointing at. The mapping unit 170 may be configured to, based on a handheld device 110 determined orientations, map at which a particular area of an object 120, the handheld device 110 is pointing at. The communication unit 180 may be configured for communication with devices 110. The communication unit 180 may be configured for communication with objects 120, if the object 120 has communication capabilities. The communication unit 180 may be configured for communication with feedback units 140. The communication unit 180 may be configured for communication with cameras 145. The communication unit 180 may be configured for communication with other related interaction nodes 100. The communication unit 180 may be configured for communication with other external sources or databases of information.

Communication may be performed over wired or wireless communication. Examples of such communication are TCP/UDP/IP (Transfer Control Protocol/User Datagram Protocol/Internet Protocol), Bluetooth, WLAN (Wireless Local Area Network), the Internet, ZigBee, not limiting to other communication suitable protocols or communication solutions.

The functional units 140, 150, 160, and 170 described above may be implemented in the interaction node 100, and 240 in the handheld device 110, by means of program modules of a respective computer program comprising code means which, when run by processor “P” 250 causes the interaction node 100 and/or the handheld device 110 to perform the above-described actions. The processor P 250 may comprise a single Central Processing Unit (CPU), or could comprise two or more processing units. For example, the processor P 250 may include general purpose microprocessors, instruction set processors and/or related chips sets and/or special purpose microprocessors such as Application Specific Integrated Circuits (ASICs). The processor P 250 may also comprise of storage for caching purposes.

Each computer program may be carried by computer program products “M” 260 in the interaction node 100 and/or the handheld device 110, shown in FIG. 8, in the form of memories having a computer readable medium and being connected to the processor P. Each computer program product M 260 or memory thus comprises a computer readable medium on which the computer program is stored e.g. in the form of computer program modules “m”. For example, the memories M 260 may be a flash memory, a Random-Access Memory (RAM), a Read-Only Memory (ROM) or an Electrically Erasable Programmable ROM (EEPROM), and the program modules m could in alternative embodiments be distributed on different computer program products in the form of memories within the interaction node 100 and/or the handheld device 110.

The interaction node 100 may be installed locally nearby a handheld device 110 and/or in the vicinity space. The interaction node 100 may be installed remotely with a service provider. The interaction node 100 may be installed with a network operator. The interaction node 100 may be installed as a cloud-type of service. The interaction node 100 may be clustered and/or partially installed at different locations. Not limiting other types of installations practical for operations of a interaction node 100.

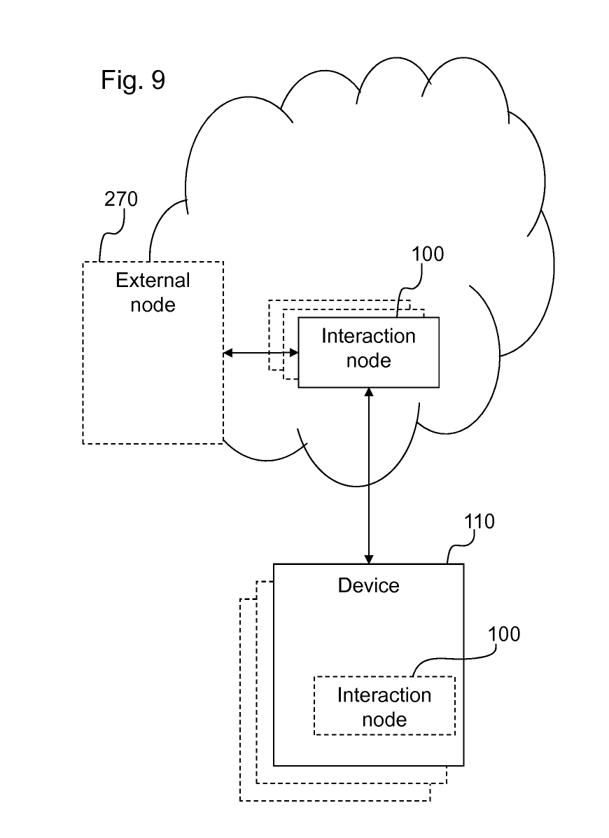

FIG. 9 illustrates some exemplifying embodiments of the solution. The interaction node 100 may be operated as a shared service, a shared application, or as a cloud type of service. As shown in the figure, the interaction node may be clustered. However, different interaction nodes 100 may have different functionality, or partially different functionality. The interaction node 100 may be connected to an external node 270. Examples of an external node may be: a node arranged for electronic commerce, a node operating a business system, a node arranged for managing advertising type of communication, or a node arranged for communication with a ware house, or a media server type of node, not limiting the external node 270 to other types of similar nodes. The external node 270 may be co-located with the interaction node 100. The external node 270 may be arranged in the same cloud as the interaction node 100, the external node 270 may be operated in a different cloud, than the interaction node, just to mention a few examples of how the interaction node 100 and the external node 270 may be related.

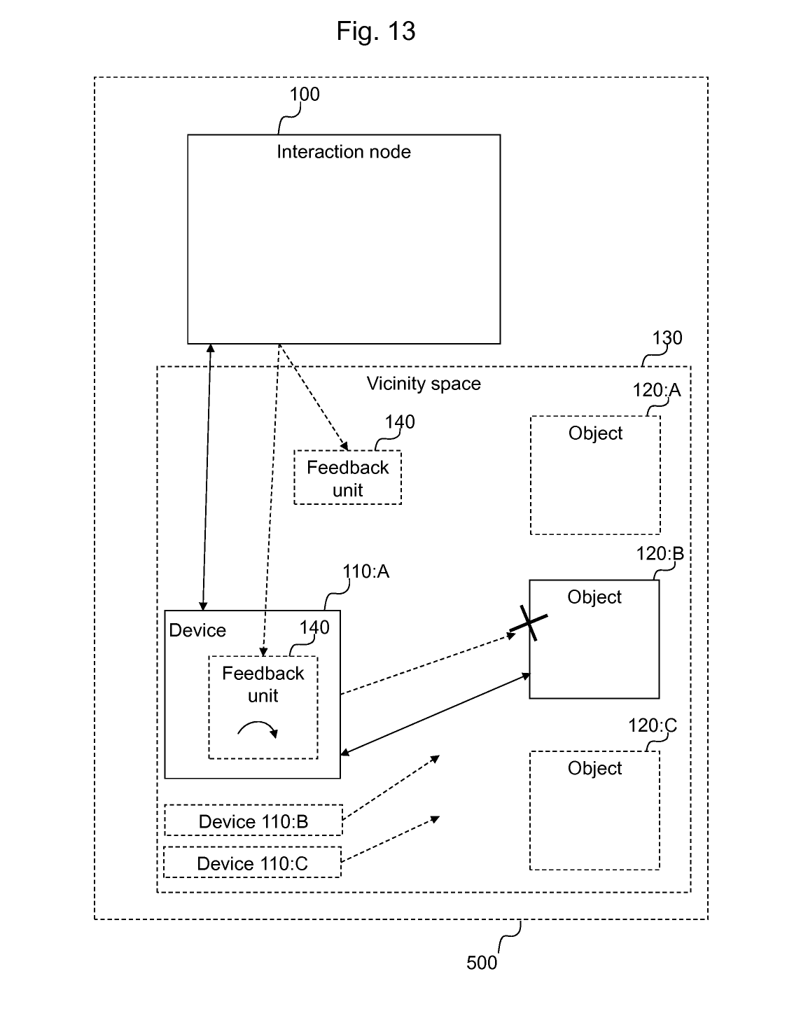

According to one embodiment, as shown in FIG. 13, an arrangement in a communication network comprising of system (500) is provided configured to enable interactivity between a handheld device 110 and an object 120, comprising:
an interaction node 100 in a communication network for enabling interactivity between a handheld device 110 and an object 120, the node:
   configured to receive at least one orientation message from the handheld device 110,
   configured to determine the handheld device 110 position and direction in a predetermined vicinity space 130,
   configured to determine an object 120 in the vicinity space 130 to which the handheld device 110 is oriented,
   configured to transmit an indicator to a feedback unit 140, which indicates that the handheld device 110 is oriented toward the object 120, the indicator confirming a desired orientation of the handheld device 110 such that the handheld device 110 is pointing at the desired object 120, and
   configured to receive an interaction message from the handheld device (110) including a selection of the object 120, thereby enabling interaction between the handheld device 110 and the object 120,
a handheld device 110 in a communication network for enabling interactivity between the handheld device 110 and an object 120, the handheld device 110:
   configured to transmit at least one orientation message to an interaction node 100, and
   configured to transmit an interaction message from the handheld device 110 including a selection of the object 120, thereby enabling interaction between the handheld device 110 and the object 120, and
   a feedback unit 140.

In a possible embodiment it may be advantageous to collocate the functionalities of the interaction node 100 together with the functionalities of handheld device 110 inside the handheld device 110.

In a possible embodiment it may be advantageous to collocate the functionalities of the feedback unit 140 together with the functionalities of handheld device 110 inside the handheld device 110.

In a possible embodiment it may be advantageous to collocate the functionalities of handheld device 110 together with the functionalities of the feedback unit 140 inside the feedback unit 140.

In a possible embodiment it may be advantageous to collocate the functionalities of the interaction node 100 together with the functionalities of feedback unit 140 inside the feedback unit 140.

There are a number of advantages with the described solution. The solution may support various business applications and processes.

An advantage is that a shopping experience may be supported by the solution. A point of sale with the solution could provide shoppers with information, e.g. product sizes, colors, prices etc., while roaming through shop facilities. Shop windows could also be used by by-passers to interact with the displayed objects, gathering associated information which could be used at the moment or stored in their devices for later consultation/consumption.

An advantage in the field of marketing and advertisement, the solution may provide a new marketing channel, bridging the physical and digital dissemination of marketing messages. By supporting digital user interactions with physical advertisement spaces, e.g. on paper billboards, banners or digital screens, users can receive additional marketing information in their terminals. This interactions, together with the actual content delivered in the terminal, can in turn be digitally shared, e.g. through social networks, effectively multiplying both the effectiveness and the reach of the initial “physical” marketing message.

An advantage may be digital shopping experience provided by the solution, transforming any surface into a “virtual” shop. By “clicking” on specific objects 120 the end users may receive coupons for specific digital or physical goods and/or directly purchase and/or receive digital goods. An example of these novel interactions could be represented by the possibility of “clicking” on a film poster displayed on a wall or displayed by a light emitting device and receiving the option of: —purchasing a digital copy of said in film to be downloaded in said user terminal, —buying movie tickets for said film in a specific theater, —reserving movie tickets for said film in a specific theater.

An advantage may be scalable control and interaction with various networked devices that is anticipated to be an important challenge for the future Internet-of-Things (IoT). The solution may reduce complexity by creating a novel and intuitive user interaction with the connected devices. By pointing at specific devices, e.g. a printer, user terminals can gather network access to the complete list of actions, e.g. print a file, which could be performed by said devices, eliminating the need of complicated procedures to establish connections, download drivers etc.

An advantage may be interaction with various everyday non-connected objects that is anticipated to be an important challenge for the future Internet-of-Things (IoT). The solution could reduce cost and complexity by creating a novel and intuitive user interaction with the non-connected objects. By pointing at specific non-connected objects, e.g. a toaster, the user can get access to information about the toaster manufacturer warranty and the maintenance instructions and/or add user satisfaction data.

An advantage may be interaction with objects 120 facilitated by the feedback unit 140 resulting in textual or graphical overlay on or near 120.

An advantage may be the practical and cost benefits of interaction on screens and flat projections versus existing multi-touch interaction, particularly when there are multiple simultaneous users. Since the solution may use off-the-shelf LCD or plasma data display panels to provide multi user interaction, hardware costs may be lower when compared to equal size multi-touch screens or panels+multi-touch overlays. And since the solution can also use of data projection systems as well as panel displays, the physical size of the interaction space may reach up to architectural scale.

Another advantage, besides cost, for display size over existing multi-touch is that the solution may remove the restriction that the screen must be within physical reach of users. An added benefit is that even smaller displays may be placed in protective enclosures, mounted high out of harm's way, or installed in novel interaction contexts difficult or impossible for touch screens.

Another advantage may be that rich media content, especially video, may be chosen from the public display (data panel or projection) but then shown on a user's handheld device 110. This may avoid a single user monopolizing the public visual and/or sonic space with playback selection, making a public multi-user rich media installation much more practical.

An advantage may be interactions on the secondary screen for TV settings. A new trend, emerging in the context of content consumption in standard TVs, is represented by the so-called secondary screen interactions, i.e. exchange on mobile terminals of information which refers to content displayed on the TV screen, e.g. commenting on a social media about the content of a TV show. By adopting the solution, a series of predetermined information may be effectively and simply made available on the devices 110 by the content providers and/or channel broadcasters. Consider an example in which users could “click” on a specific character on the screen receiving on the mobile device information, e.g. the price and e-shop where to buy the clothes that the character is wearing, the character social media feed or social media page, information concerning other shows and movies featuring this character etc. Using the solution, content provider and broadcaster have the possibility of creating a novel content flow, which is parallel to the visual content on the TV channel, and that constitutes of novel relevant business channel on the secondary screens.

While the solution has been described with reference to specific exemplary embodiments, the description is generally only intended to illustrate the inventive concept and should not be taken as limiting the scope of the solution. For example, the terms “interaction node”, “device”, vicinity space and “feedback unit” have been used throughout this description, although any other corresponding nodes, functions, and/or parameters could also be used having the features and characteristics described here.

1. A method in an interaction node in a communication network for enabling interactivity between a handheld device and an object, the method comprising:
receiving at least one orientation message from the handheld device,
determining the handheld device position and orientation in a predetermined vicinity space,
determining an object in the vicinity space to which the handheld device is oriented,
transmitting an indicator to a feedback unit, which indicates that the handheld device is oriented toward the object, the indicator confirming a desired orientation of the handheld device such that the handheld device is pointing at the desired object, and
receiving an interaction message from the handheld device including a selection of the object, thereby enabling interaction between the handheld device and the object.

2. The method according to claim 1, wherein
the object has at least one:
a pre-determined position in the vicinity space determined by use of information of a spatial database, and
a dynamically determined position in the vicinity space, determined by use of information from vicinity sensors.

3. The method according to claim 1, wherein
the feedback unit is a light emitting unit, wherein
the transmitted indicator includes an instruction to emit a pointer at the object, coincident with the object in the orientation of the handheld device.

4. The method according to claim 1, wherein
an accuracy of the orientation is indicated by visual characteristics of the pointer.

5. The method according to claim 1, wherein
the handheld device and the feedback unit are associated, wherein
the transmitted indicator includes an instruction to generate at least one of:
haptic signal, audio signal, and visual signal that confirms that the handheld device is oriented toward the object.

6. The method according to claim 1, comprising
transmitting the received interaction message to the object, wherein
network address information to the handheld device is added to the transmitted interaction message, enabling direct communication between the object and the handheld device.

7. The method according to claim 1, comprising
transmitting an image of the vicinity space to the handheld device, the image describing an area and at least one object within the area, wherein
the area is determined by the handheld device position and orientation, corresponding to a virtual projection based on the handheld device position and orientation.

8. The method according to claim 1, comprising
receiving a first image of the projection from the handheld device or a camera the image including at least one captured object,
mapping the at least one object captured in the image with the corresponding object in the spatial database, and
transmitting a second image to the handheld device, wherein
the second image includes information and/or instructions for creation of at least one interaction message related to the at least one object.

9. The method according to claim 1, comprising
receiving orientation messages from a plurality of devices, wherein
each orientation message is individually handled.

10. The method according to claim 1, comprising
selecting of a set of possible interaction manifestations for manifestation at the handheld device,
transmitting the set of possible interaction manifestations to the handheld device
receiving an activation message from the handheld device, including an activation of an interaction manifestation.

11. The method according to claim 1, whereby
selecting of a set of possible interaction manifestations for manifestation at the handheld device is carried out based on different types of context information comprising at least one of time, location, characteristics of the user or plurality of users, device type, device energy levels, device screen resolution, and network information.

12. The method according to claim 1, whereby
the transmitted set of possible interaction manifestations for manifestation at the handheld device varies in time in the device according to a schedule.

13. The method according to claim 1, comprising
selecting an interaction manifestation for manifestation at the object based on context information comprising at least one of time, location, characteristics of the user or a plurality of users, device type, object type and network information.

14. The method according to claim 1, comprising
transmitting a request message to the object including a request to alter the manifestation at the object.

15. The method according to claim 1, comprising
selecting an interaction manifestation for manifestation at a plurality of objects which may comprise the selected object.

16. The method according to claim 1, comprising
transmitting a request message to a plurality of objects, which may comprise the selected object, including a request to alter the manifestation at the plurality of objects.

17. An interaction node in a communication network for enabling interactivity between a handheld device and an object, the node:
configured to receive at least one orientation message from the handheld device,
configured to determine the handheld device position and orientation in a predetermined vicinity space,
configured to determine an object in the vicinity space to which the handheld device is oriented,
configured to transmit an indicator to a feedback unit, which indicates that the handheld device is oriented toward the object, the indicator confirming a desired orientation of the handheld device such that the handheld device is pointing at the desired object, and
configured to receive an interaction message from the handheld device including a selection of the object, thereby enabling interaction between the handheld device and the object.

18. The node according to claim 17, wherein
the object has at least one:
a pre-determined position in the vicinity space determined by use of information of a spatial database, and
a dynamically determined position in the vicinity space, determined by use of information from vicinity sensors.

19. The node according to claim 17, wherein
the feedback unit is a light emitting unit, wherein
the transmitted indicator includes an instruction to emit a pointer at the object, coincident with the object in the orientation of the handheld device.

20. The node according to claim 17, wherein
an accuracy of the orientation is indicated by visual characteristics of the pointer.

21. The node according to claim 17, wherein
the handheld device and the feedback unit are associated, wherein
the transmitted indicator includes an instruction to generate at least one of:
haptic signal, audio signal, and visual signal that confirms that the handheld device is oriented toward the object.

22. The node according to claim 17, wherein
the node is arranged to transmit the received interaction message to the object, wherein
network address information to the handheld device is added to the transmitted interaction message, enabling direct communication between the object and the handheld device.

23. The node according to claim 17, wherein
the node is arranged to transmit an image of the vicinity space to the handheld device, the image describing an area and at least one object within the area, wherein
the area is determined by the handheld device position and orientation, corresponding to a virtual projection based on the handheld device position and orientation.

24. The node according to claim 17, wherein
the node is arranged to receive a first image of the projection from the handheld device or a camera the image including at least one captured object,
the node is arranged to map the at least one object captured in the image with the corresponding object in the spatial database, and
the node is arranged to transmit a second image to the handheld device, wherein
the second image includes information and/or instructions for creations of at least one interaction message related to the at least one object.

25. The node according to claim 17, wherein
the node is arranged to receive an orientation messages from a plurality of devices, wherein
each orientation message is individually handled.

26. The node according to claim 17, wherein
the node is arranged to select a set of possible interaction manifestations for manifestation at the handheld device,
the node is arranged to transmit the set of possible interaction manifestations to the handheld device, the node is arranged to receive an activation message from the handheld device, including an activation of an interaction manifestation.

27. The node according to claim 17, wherein
selecting of a set of possible interaction manifestations for manifestation at the handheld device is arranged to be carried out based on different type of context information comprising at least one of time, location, characteristics of the user, device type, device energy levels, device screen resolution, and network information.

28. The node according to claim 17, wherein
the transmitted set of possible interaction manifestations for manifestation at the handheld device is adapted to vary in time in the device according to a schedule.

29. The node according to claim 17, wherein
the node is arranged to select an interaction manifestation for manifestation at the object based on context information comprising at least one of time, location, characteristics of the user or a plurality of users, device type, object type, and network information.

30. The node according to claim 17, wherein
the node is arranged to transmit a request message to the object including a request to alter the manifestation at the object.

31. The node according to claim 17, wherein
the node is arranged to select an interaction manifestation for manifestation at a plurality of objects which may comprise the selected object.

32. The node according to claim 17, wherein
the node is arranged to transmit a request message to a plurality of objects, which may comprise the selected object, including a request to alter the manifestation at the plurality of objects.

33. A method in an handheld device in a communication network for enabling interactivity between the handheld device and an object, the method comprising:
transmitting at least one orientation message to an interaction node, and
transmitting an interaction message from the handheld device including a selection of the object, thereby enabling interaction between the handheld device and the object.

34. The method according to claim 33, comprising:
receiving an indicator to a feedback unit, which indicates that the handheld device is oriented toward the object, the indicator confirming a desired orientation of the handheld device such that the handheld device is pointing at the desired object.

35. The method according to claim 33, wherein
the handheld device and the feedback unit are associated, wherein
the received indicator includes an instruction to generate at least one of:
haptic signal, audio signal, and visual signal that confirms that the handheld device is oriented toward the object.

36. The method according to claim 33, comprising
receiving a vicinity image of the vicinity space, the image describing an area and at least one object within the area, wherein
the area is determined by the handheld device position and orientation, corresponding to a virtual projection based on the handheld device position and orientation.

37. The method according to claim 33, comprising
transmitting a first captured image of the projection to the interaction node, the first captured image including at least one captured object, and
receiving a second captured image to the handheld device, wherein
the second captured image includes information and/or instructions for creations of at least one interaction message related to the at least one object.

38. The method according to claim 33, comprising
receiving a set of possible interaction manifestations,
transmitting an activation message to an interaction node, including an activation of an interaction manifestation.

39. A handheld device in a communication network for enabling interactivity between the handheld device and an object, the handheld device:
configured to transmit at least one orientation message to an interaction node, and
configured to transmit an interaction message from the handheld device including a selection of the object, thereby enabling interaction between the handheld device and the object.

40. The device according to claim 39, wherein:
the device is arranged to receive an indicator to a feedback unit, which indicates that the handheld device is oriented toward the object, the indicator confirming a desired orientation of the handheld device such that the handheld device is pointing at the desired object.

41. The device according to claim 39, wherein
the handheld device and the feedback unit are associated, wherein
the received indicator includes an instruction to generate at least one of:
haptic signal, audio signal, and visual signal that confirms that the handheld device is oriented toward the object.

42. The device according to claim 40, wherein
the device is arranged to receive a vicinity image of the vicinity space, the image describing an area and at least one object within the area, wherein
the area is determined by the handheld device position and orientation, corresponding to a virtual projection based on the handheld device position and orientation.

43. The device according to claim 40, wherein
the device is arranged to transmit a first captured image of the projection to the interaction node, the first captured image including at least one captured object, and
the device is arranged to receive a second captured image to the handheld device, wherein
the second captured image includes information and/or instructions for creations of at least one interaction message related to the at least one object.

44. The device according to claim 39, wherein
the device is arranged to receive a set of possible interaction manifestations,
the device is arranged to transmit an activation message to an interaction node, including an activation of an interaction manifestation.

45. (canceled)

46. (canceled)

47. (canceled)

48. (canceled)

49. An arrangement in a communication network comprising of system (500) configured to enable interactivity between a handheld device and an object, comprising:
an interaction node in a communication network for enabling interactivity between a handheld device and an object, the node:
configured to receive at least one orientation message from the handheld device,
configured to determine the handheld device position and direction in a predetermined vicinity space,
configured to determine an object in the vicinity space to which the handheld device is oriented,
configured to transmit an indicator to a feedback unit, which indicates that the handheld device is oriented toward the object, the indicator confirming a desired orientation of the handheld device such that the handheld device is pointing at the desired object, and
configured to receive an interaction message from the handheld device including a selection of the object, thereby enabling interaction between the handheld device and the object,
a handheld device in a communication network for enabling interactivity between the handheld device and an object, the handheld device:
configured to transmit at least one orientation message to an interaction node, and
configured to transmit an interaction message from the handheld device including a selection of the object, thereby enabling interaction between the handheld device and the object, and
a feedback unit.
